(19) United States
(12) Patent Application Publication
(10) Pub. No.: US 2007/0233992 A1
(43) Pub. Date: Oct. 4, 2007

(54) Storage apparatus

(75) Inventor: Eiichi Sato, Hiratsuka (JP)

Correspondence Address: Stanley P. Fisher;REED SMITH LLP, Suite 1400, 3110 Fairview Park Drive, Falls Church, VA, 22042, US

(73) Assignee: Hitachi, Ltd.

(21) Appl. No.: 11/436,540

(22) Filed: May 19, 2006

(30) Foreign Application Priority Data
Mar. 28, 2006 (JP) 2006-088859

(51) Int. Cl. G06F 12/00

(52) U.S. Cl. 711/170

(57) ABSTRACT

Provided is a storage apparatus capable of realizing the effective utilization of a storage resource having an offline volume. This storage apparatus has a memory apparatus and a controller, and which controls the input and output of data to and from the memory apparatus according to a request from a host system connected via a communication path, and includes: a virtual volume to be accessed by the host system; and a real volume having a storage extent of the memory apparatus; wherein the host system is configured to access the storage extent of the real volume via the virtual volume by the real volume being allocated to the virtual volume; and wherein the capacity of the storage extent of the real volume to be allocated to the virtual volume is changeable.

### CROSS-REFERENCES TO RELATED APPLICATIONS

This application relates to and claims priority from Japanese Patent Application No. 2006-88859, filed on Mar. 28, 2006, the entire disclosure of which is incorporated herein by reference.

### BACKGROUND

The present invention relates to a storage apparatus for controlling the storage of data in a memory apparatus such as a hard disk drive (hereinafter referred to as a “HDD”).

Capacity of the storage extent in a storage apparatus is becoming enlarged pursuant to the increase in the data volume handled in a computer system including a storage apparatus, a server connected to this storage apparatus via a communication path such as a network, and a host system such as a host computer.

A storage apparatus logically defines a volume that is accessible by the host system, and allocates a physical storage extent of a memory apparatus to this logical volume. The host system is able to input and output data to and from the memory apparatus by accessing the volume. Recently, since the data volume handled by the host system is increasing considerably, it is necessary to substantially increase the volume size, which is the storage capacity of the volume. Incidentally, Japanese Patent Laid-Open Publication No. 2005-10997 describes a storage apparatus enabling access to a volume that is in an offline state to the host system in addition to enabling access to a volume that is in an online state.

### SUMMARY

If the volume size becomes too large, since such volume will be fixed to a specific host system, the storage resource of the storage apparatus will not be used effectively. Meanwhile, even upon increasing the number of volumes and enabling more host systems to access the storage apparatus, the number of volumes that can be defined in the storage apparatus is limited.

Thus, by configuring a virtual volume, which can be recognized by the host system but which does not in itself have a real storage extent, in the storage apparatus, and allocating a real volume having a physical storage extent to the virtual volume, the host system is able to input and output data to and from the real volume via the virtual volume. According to this method, the host system is able to access the target physical volume without having to increase the virtual volume.

Generally speaking, a real volume is placed in an offline state that is not accessible by the host system and becomes online by the offline volume being mapped to the virtual volume in response to a request from the host system, whereby the host system is able to access the real volume. According to this configuration, since it is not necessary to fix an offline volume to a specific host system, the host system is able to effectively use the storage resource of the storage.

With this type of computer system, a maximum volume size, which is defined by the operating system of a business server as the host system, is allocated to the offline volume. When a business server accesses the online volume and writes data, the storage apparatus releases the online volume from its allocation to the virtual volume and returns it to the state of an offline volume. Then, the storage apparatus allocates the offline volume to the backup server and executes the backup of the offline volume with the backend of the business server.

Nevertheless, even if only a part of the offline volume is used by the business server, backup processing is performed to all storage extents of the offline volume in referral processing such as a backup. During this time, since it is not possible to release to another host system the storage capacity that is not being used by the business server in update processing or the like, there is a problem in that the effective utilization of the storage resource of the storage apparatus cannot be sought.

Thus, an object of the present invention is to provide a storage apparatus capable of effectively using the storage resource. And another object of the present invention is to provide a storage apparatus capable of effectively utilizing a storage resource having an offline volume.

In order to achieve the foregoing objects, the present invention allocates an offline volume to a virtual volume so as to enable a host system to recognize the offline volume via this virtual volume, and further changes the storage capacity of the volume upon allocating an offline volume to the virtual volume and realizing an online state to the host system.

More specifically, the present invention provides a storage apparatus having a memory apparatus and a controller, and which controls the input and output of data to and from the memory apparatus according to a request from a host system connected via a communication path, including: a virtual volume to be accessed by the host system; and a real volume having a storage extent of the memory apparatus; wherein the host system is configured to access the storage extent of the real volume via the virtual volume by the real volume being allocated to the virtual volume; and wherein the controller is able to make the capacity of the storage extent of the real volume to be allocated to the virtual volume variable.

As described above, according to the present invention, since the controller is able to make the capacity of the storage extent of the real volume to be allocated to the virtual volume variable, it is possible to provide a storage apparatus capable of effectively using the storage resource. Further, it is also possible to provide a storage apparatus capable of effectively utilizing a storage resource having an offline volume.

### DESCRIPTION OF DRAWINGS

FIG. 1 is a hardware block diagram showing the storage control system including the storage apparatus employing the present invention;

FIG. 2 is a block diagram showing the volume management operation of the storage apparatus in the storage control system illustrated in FIG. 1;

FIG. 3 is a functional block diagram showing the storage apparatus volume control operation;

FIG. 4 is a functional block diagram for explaining the control operation of the server (business, backup), management server and storage apparatus;

FIG. 5 is a diagram showing a configuration example of the path configuration management table;

FIG. 6 is a configuration example of the variable offline volume management table configured in the storage apparatus;

FIG. 7 is a diagram showing an example of the variable offline area management table;

FIG. 8 is a management table showing the relationship of the pool extent ID of the pool extent illustrated in FIG. 2, total storage capacity of the storage extent belonging thereto, storage capacity allocated to the offline volume, and remaining storage capacity;

FIG. 9 is a diagram showing an example of the variable offline volume group (area) management table;

FIG. 10 is a diagram showing an example of the permission server and permission port management table;

FIG. 11 is a timing chart showing the allocation of the variable offline volume to the virtual volume, and release processing after such allocation;

FIG. 12 is a flowchart showing the operation of initializing the pool extent retaining the physical volume allocated to the variable offline volume in the storage apparatus;

FIG. 13 is a flowchart showing the initialization of the variable offline volume extent;

FIG. 14 is a flowchart showing the operation of the initial allocation/path configuration of the virtual volume;

FIG. 15 is a flowchart for explaining the initial allocation of the variable offline volume group;

FIG. 16 is a flowchart showing the initial allocation operation of the variable offline volume;

FIG. 17 is a flowchart showing the initial allocation processing of the variable offline volume to the variable offline volume group;

FIG. 18 is a flowchart showing the initial allocation processing of the permission server and permission port;

FIG. 19 is a flowchart showing the initial allocation processing to the variable offline volume group of the permission server and permission port;

FIG. 20 is a flowchart for explaining the allocation processing to the virtual volume of the variable offline volume;

FIG. 21 is a flowchart for explaining the allocation processing to the virtual volume of the variable offline volume, and is a flowchart showing the processing to be performed subsequent to the processing depicted in FIG. 20;

FIG. 22 is a flowchart showing the processing flow of releasing, from the virtual volume, the variable volume that became online as a result of being allocated to the virtual volume;

FIG. 23 is a block diagram showing the processing flow of the business server designating the variable offline volume group, and collectively allocating a plurality of variable offline volumes to a plurality of virtual volumes;

FIG. 24 is a hardware block diagram of the storage control system showing that the storage extent allocated to the variable offline volume is provided from another storage apparatus connected externally to the storage apparatus;

FIG. 25 is a hardware block diagram showing a configuration example of the variable offline volume in consideration of the generation management of data of the variable offline volume; and

FIG. 26 is a management table for executing the generation management of the variable offline volume.

### DETAILED DESCRIPTION

Embodiments of the present invention are now explained in detail with reference to the attached drawings. Incidentally, the same reference numerals are given to the same components in the drawings explained below, and the repetitive explanation thereof is omitted or simplified.

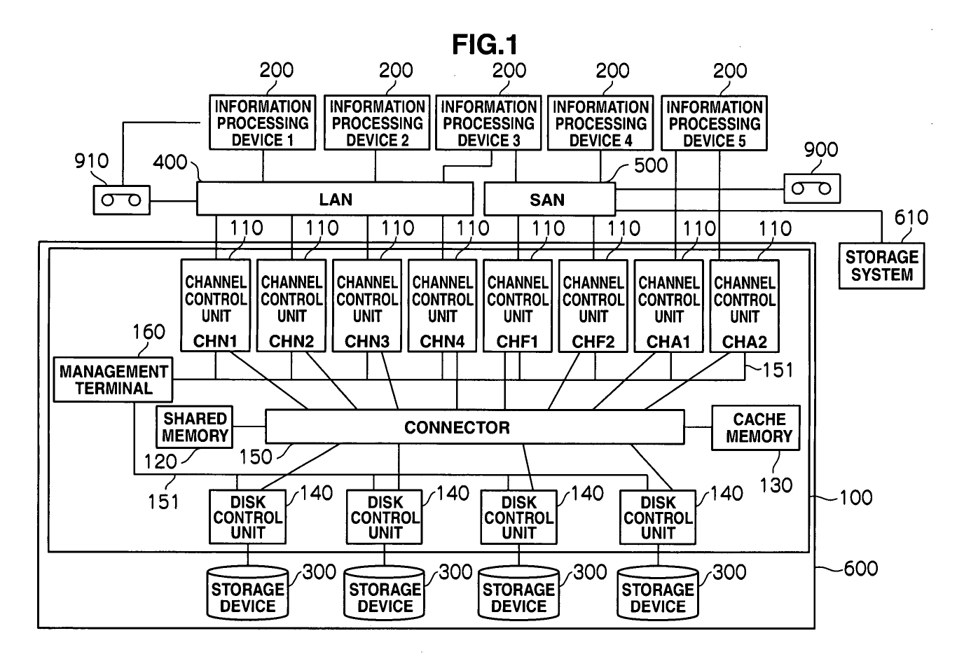

FIG. 1 is a hardware block diagram showing the storage control system including a storage apparatus (sometimes referred to as a “storage system”) 600 applying the present invention. The storage apparatus 600 is configured by including a plurality of storage devices 300, and a storage device controller 100 for controlling the input and output of [data] to and from the storage devices 300 in response to an I/O request from an information processing device 200.

The information processing device 200 is a management computer of a server or a storage apparatus including a CPU, memory and the like, and, for instance, is configured from a workstation, mainframe computer, personal computer or the like. The information processing device 200 may also be configured by network-connecting a plurality of computers. The information processing device 200 is loaded with an application program that operates according to the operating system. As an application program, for example, there is the ATM system of banks and seat reservation systems of airline companies. Further, as a server, there is an update server or a backup server that executes backup with the backend of such update server for executing the application.

The information processing devices 1 to 3 (200) are connected to the storage apparatus 600 via a LAN (Local Area Network) 400. The LAN 400, for instance, is a communication network such as the Ethernet (registered trademark) or FDDI, and communication between the information processing devices 1 to 3 (200) and the storage apparatus 600 is conducted based on a TCP/IP protocol. The information processing device 1 to 3 (200) sends to the channel controllers CHN 1 to CHN 4 (110) described later a data access request (data I/O request in file units; hereinafter referred to as a “file access request”) designating a file name to the storage apparatus 600.

The LAN 400 is connected to a backup device 910. The backup device 910, for instance, is a disk device such as an MO, CD-R or DVD-RAM, or a tape device such as a DAT, cassette tape, open tape or cartridge. The backup device 910 stores backup data of data stored in the storage device 300 by communicating with the storage device controller 100 via the LAN 400. Further, the backup device 910 connects to the information processing device 1 (200) and acquires the backup of data stored in the storage device 300 via the information processing device 1 (200).

A storage device controller 100 includes channel controllers CHN 1 to 4 (110). The storage device controller 100 intermediates the write access or read access among the information processing device 1 to 3 (200) and backup device 910 and storage device 300 via the channel controllers CHN 1 to 4 (110) and LAN 400. The channel controllers CHN 1 to 4 (110) individually accept a file access request from the information processing devices 1 to 3 (200). In other words, each channel controller CHN 1 to 4 (110) is allocated a network address (IP address for example) on the LAN 400 so as to individually function as a NAS, and is capable of providing to the information processing devices 1 to 3 (200) a NAS service as though each NAS is an independent. NAS. As described above, since a single storage apparatus 600 is configured to include the channel controllers CHN 1 to 4 (110) capable of individually providing a NAS service, the NAS servers which were conventionally operated by independent computers can be consolidated into a single storage apparatus 600. And, as a result, the overall control of the storage apparatus 600 is enabled, and the streamlining of various settings and controls as well as maintenance procedures such as failure management and version management can be sought.

The information processing devices 3 and 4 (200) are connected to the storage device controller 100 via a SAN 500. The SAN 500 is a network for sending and receiving data to and from the information processing devices 3 and 4 (200) in block units, which is a the management unit of data in the storage extent provided by the storage device 300. Communication between the information processing device 3 and 4 (200) and storage device controller 100 via the SAN 500 is generally conducted according to a fibre channel protocol. The information processing devices 3 and 4 (200) send to the storage apparatus 600 a data access request in block units (hereinafter referred to as a “block access request”) according to the fibre channel protocol.

A SAN-compatible backup device 900 is connected to the SAN 500. The SAN-compatible backup device 900 stores the backup data of data stored in the storage device 300 by communicating with the storage device controller 100 via the SAN 500.

In addition to the channel controllers CHN 1 to 4 (110), the storage device controllers 100 also include channel controllers CHF 1 and 2, CHN [1] and 2 (110). The storage device controller 100 conducts the communication between the information processing devices 3 and 4 (200) and SAN-compatible backup device 900 via the channel controllers CHF 1 and 2 (110) and SAN 500.

The information processing device 5 (200) is also connected to the storage device controller 100 without going through a network such as the LAN 400 or SAN 500. The information processing device 5 (200) in this example, for instance, is a mainframe computer. Communication between the information processing device 5 (200) and storage device controller 100, for instance, is conducted according to a communication protocol such as FICON (Fiber Connection)®, ESCON (Enterprise System Connection)®, ACONARC (Advanced Connection Architecture)® or FIBARC (Fiber Connection Architecture)®. The information processing device 5 (200) sends a block access request to the storage apparatus 600 according to such communication protocol. The storage device controller 100 communicates with the information processing device 5 (200) via the channel controllers CHN 1 and 2 (110).

Connected to the SAN 500 is another storage apparatus 610 installed at a location (secondary site) remote from the installation site (primary site) of the storage apparatus 600. The storage apparatus 610 provides to the information processing device and storage apparatus 600 a function of providing a storage resource of the storage apparatus to the storage device controller 100. The apparent storage extent to the information processing device of the storage apparatus is thereby expanded by the storage apparatus 610. Incidentally, the storage apparatus 610 may also be connected to the storage apparatus 600 via a communication line of an ATM or the like in addition to the SAN 500. Further, the storage apparatus 610 may also be connected directly to the storage apparatus 600. As the channel controllers 110 to be connected to the SAN 500, channel controllers having an interface (channel extender) for using the foregoing communication line are adopted.

As described above, by mixing and installing the channel controllers CHN 1 to 4 (110), channel controllers CHF 1 and 2 (110), and channel controllers CHN 1 and 2 (110) in the storage apparatus 600, a storage apparatus capable of connecting different networks is realized. In other words, this storage apparatus 600 is a SAN-NAS integrated storage apparatus which connects to the LAN 400 through the channel controllers CHN 1 to 4 (110), and connects to the SAN 500 through the channel controllers CHF 1 and 2 (110).

The connection 150 mutually connects the respective channel controllers 110, shared memory 120, cache memory 130, and respective disk controllers 140. The sending and receiving of commands or data among these channel controllers 110, shared memory 120, cache memory 130, and disk controllers 140 are conducted via the connection 150. The connection 150, for example, is configured from a high-speed bus such as an ultra fast crossbar switch that transmits data by high-speed switching. Thereby, the communication performance among the channel controllers 110 will improve considerably, and high-speed file sharing functions and high-speed failover and so on are enabled.

The shared memory 120 and cache memory 130 are memory devices to be shared by the channel controllers 110 and disk controllers 140. The shared memory 120 is primarily used for storing control information and commands, and the cache memory 130 is primarily used for storing data. For example, when a data I/O command received by a certain channel controller 110 from the information processing device 200 is a write command, such channel controller 110 writes this write command in the shared memory 120, and also writes the write data received from the information processing device 200 in the cache memory 130. Meanwhile, the disk controllers 140 are monitoring the shared memory 120, and, when they determine that a write command has been written in the shared memory 120, they read the write data from the cache memory 130 according to the write command and write this in the storage device 300.

Meanwhile, when a data I/O command received by a certain channel controller 110 from the information processing device 200 is a read command, such channel controller 110 writes this read command in the shared memory 120, and checks whether the data to be read exists in the cache memory 130. Here, when the data to be read exists in the cache memory 130, the channel controller 110 reads the data from the cache memory 130 and sends it to the information processing device 200. When the data to be read does not exist in the cache memory 130, the disk controller that detected the writing of the read command in the shared memory 120 reads the data to be read from the storage device 300 and writes this in the cache memory 130, and writes to such effect in the shared memory 120. As a result of the channel controller 110 monitoring the shared memory 120 and detecting that the data to be read has been written in the cache memory 130, the channel controller 110 reads such data from the cache memory 130 and sends it to the information processing device 200.

The disk controller 140 converts the data access request to the storage device 300 designating a logical address sent from the channel controller 110 into a data access request designating a physical address, and writes or reads data in and from the storage device 300 in response to the I/O request output from the channel controller 110. When the storage device 300 is configured in RAID, the disk controller 140 accesses data according to the RAID configuration. In addition, the disk controller 140 performs the replication control or remote copy control for the purpose of replication management of data stored in the storage device 300, data loss prevention (disaster recovery) during a disaster, and so on.

The storage device 300 has one or more disk drives (physical volumes), and provides a storage extent accessible from the information processing device 200. A logical volume combining the storage spaces of the one or more physical volumes is configured in the storage extent provided by the storage device 300. The logical volume configured in the storage device 300 includes a user logical volume accessible from the information processing device 200 and system logical volume used for controlling the channel controller 110. The system logical volume also stores an operating system to be executed by the channel controller 110. Further, a logical volume accessible by the respective channel controllers 110 is allocated to the logical volume provided by the storage device 300 to the host system. In addition, a plurality of channel controllers 110 may share the same logical volume.

Incidentally, as the storage device 300, for instance, a hard disk device or flexible disk device may be used. As the storage configuration of the storage device 300, for instance, a disk array according to a RAID system may be configured from a plurality of storage devices 300. Further, the storage device 300 and storage device controller 100 may be connected directly, or connected via a network. Moreover, the storage device 300 may also be configured integrally with the storage device controller 100.

The management terminal 160 is a computer device for maintaining and managing the storage apparatus 600, and is connected to the respective channel controllers 110 and disk controllers 140 via the internal LAN 151. By operating the management terminal 160, the operator is able to configure the disk drives and configure the logical volume of the storage device 300, and install the micro programs to be executed by the channel controllers 110 and disk controllers 140.

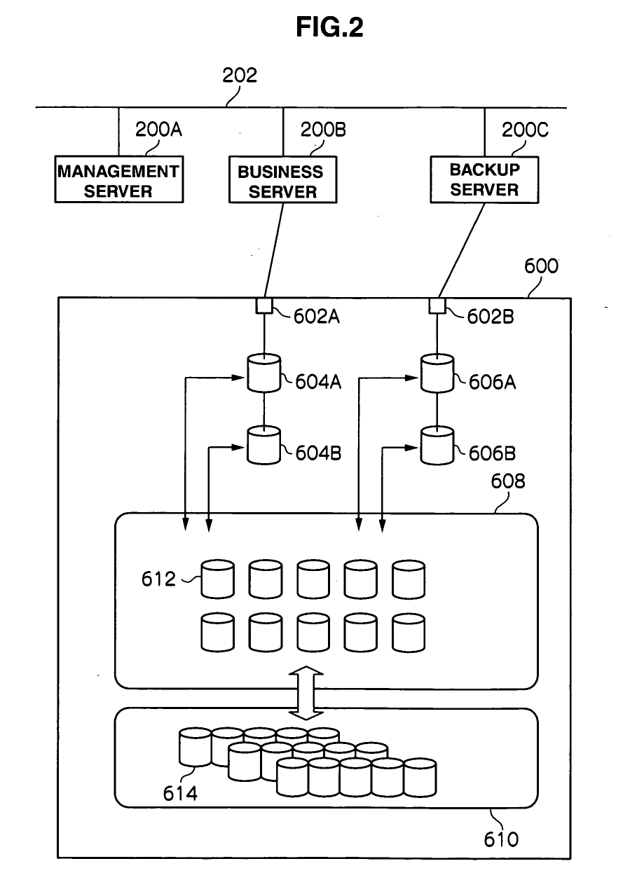

FIG. 2 is a block diagram showing the volume management operation of the storage apparatus in the storage control system illustrated in FIG. 1. In FIG. 2, a network 202 is used for connecting the storage apparatus 600 and host systems 200A to 200C. A business server 200B is connected to a port 602A of the storage apparatus, and a backup server is connected to a port 602B. Virtual volumes 604A, 604B are allocated to the port 602A. Although the business server 200B is able to recognize and access the virtual volumes 604A, 604B, since the virtual volumes themselves are not allocated to a unique storage extent, the business server 200B is not able to input and output data to and from the virtual volumes. Virtual volumes 606A, 606B are allocated to the port 602B. Although the backup server 200C is able to recognize and access the virtual volumes 606A, 606B, since the virtual volumes 606A, 606B themselves are not allocated to a unique physical storage extent, the backup server 200C is not able to read data from the virtual volumes 606A, 606B and back up such data in a tape device not shown.

A variable offline volume extent 608 is configured from a plurality of logical volumes 612. Since a physical storage extent is allocated to the logical volume 612, the logical volume 612 corresponds to a “real volume”. This real volume is placed in an offline state to the access from the host system, and the host system is not able to access the real volume. By respectively allocating the real volumes 612 to the virtual volumes 604A, 604B, 606A, 606B, the business server is able to access the real volumes 612 via the virtual volumes 604A, 604B.

A physical storage extent 614 is to be allocated to the real volume, and a pool extent 610 accumulates such physical volume by differentiating it from a plurality of other storage extents. By the storage apparatus 600 allocating the physical volume 614 in the pool extent 610 to the real volume 612, the business server is able to access the storage extent 614 via the virtual volume 604A, 604B. The same applies to the backup server 200C. The storage apparatus 600 is able to suitably configure the storage capacity of the physical volume 614 to be allocated to the real volume 612. In other words, the storage capacity of the real volume 612 is variable. Therefore, the real volume 612 corresponds to a variable offline volume having a volume size that is variable. Incidentally, functions of a management server 200A will be explained later.

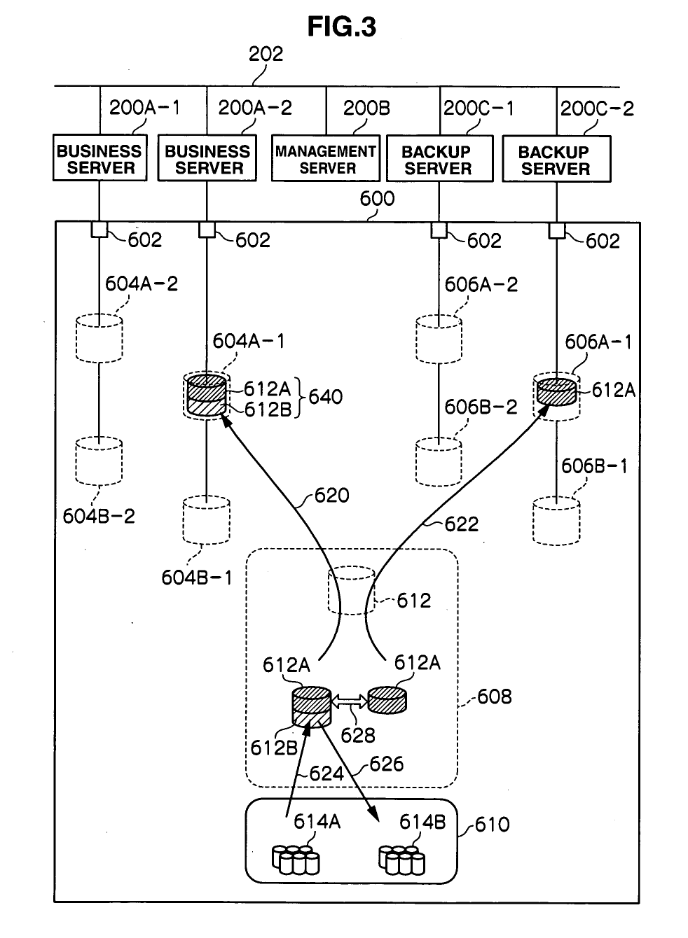

FIG. 3 is a functional block diagram showing the volume control operation of the storage apparatus 600. In FIG. 3, reference numeral 620 shows the operation of the storage apparatus 600 allocating the variable offline volume 612 to a virtual volume 604A-1 to be accessed by a business server 200A-2. Reference numeral 622 shows the operation of the storage apparatus 600 allocating the variable offline volume 612 to a virtual volume 604A-1 to be accessed by a backup server 200C-2.

When the storage apparatus 600 allocates the variable offline volume 612 to the virtual volume 604A-1, the maximum volume size defined by the operating system of the business server 200A-2 is configured in the variable offline volume 612. Among all storage extents of the variable offline volume 612, reference numeral 612A represents the extent (real used extent) accessed by the business server and in which data was written. Contrarily, reference numeral 612B is an unused extent that is not being used by the business server. When the storage apparatus 600 allocates the variable offline volume to the virtual volume 606A-1, the real used extent 612A becomes the storage extent of the variable offline volume, and the variable offline volume is allocated to the virtual volume.

When the storage apparatus 600 allocates the variable offline volume 612 to the virtual volume 604A-1, the insufficient storage capacity 612B of the maximum storage capacity 640 is supplemented from the unused storage extent 614A of the pool extent 610 to the variable offline volume 612 (624). Meanwhile, after the online state to the virtual volume 604A-1 of the variable offline volume 612 is released, when allocating the offline volume 612 to the backup server 200C-2, the storage extent 612A configuring the real used extent is allocated to the virtual volume 606A-1, and the unused extent 612B is returned to the pool extent 610 (626).

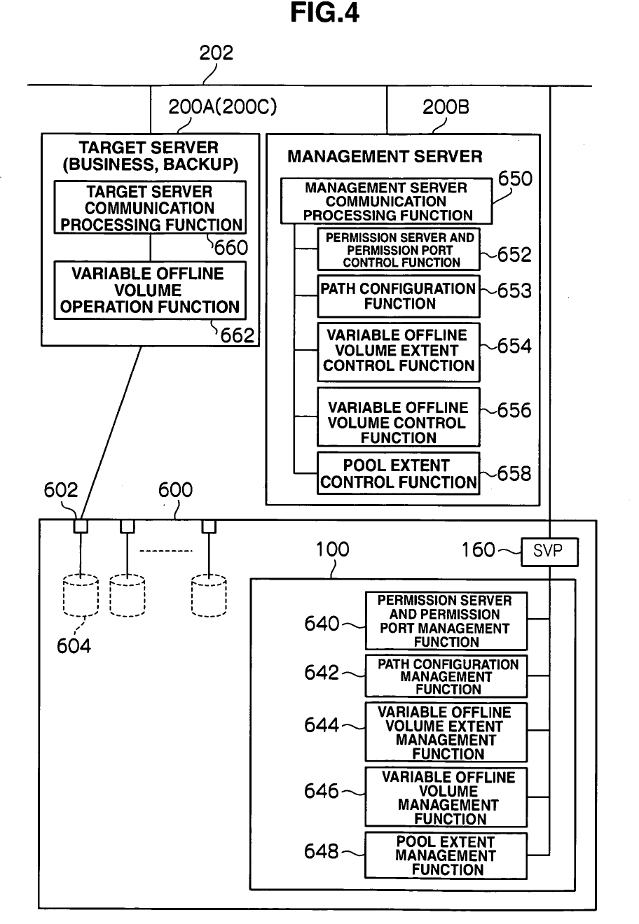

FIG. 4 is a functional block diagram for explaining the control operation of the server (business, backup) 200B (200C), management server 200A, and storage apparatus 600. The disk controllers 100 of the storage apparatus 600 achieve the respective functions illustrated in FIG. 4. A permission server and permission port management function 640 manages and processes information, upon allocating a variable offline volume to the virtual volume 604, regarding the server 200B (or 200C) and port 602 which are permitted to receive the allocation of the variable offline volume. A path configuration management function 642 manages and processes the path configuration and virtual volume information (volume mode and so on) upon defining the path of the virtual volume.

Here, a volume mode is control information for prescribing which storage extent of which capacity is to be allocated to the real volume upon allocating a real volume to the virtual volume, and there is a mode (maximum value mode) for allocating the maximum capacity (640 of FIG. 3) to the real volume, or a mode (used value mode) for allocating the real used extent (612 of FIG. 3) to the virtual volume. A management terminal (SVP) 160 or management server 200B configures this mode in the virtual volume of the storage apparatus 600. The former mode, as shown in FIG. 3, is configured in the virtual volume 604 (604A-1, 2;604B-1, 2) to be accessed by the host system that performs update and addition processing of the business server 200B and the like. The latter mode is configured in the virtual volume (606A-1, 2;606B-1, 2) to be accessed by the host system that performs referral processing of the backup server 200C and the like.

A variable offline volume management function 646 manages and processes the respective variable offline volumes stored in the storage apparatus (storage subsystem) 600. A variable offline volume extent management function 644 manages and processes the variable offline volume extent ID, which is a variable offline volume extent for managing the variable offline volume. A pool extent management [function] 648 manages and processes the pool extent for securing the unused extent upon allocating a variable offline volume to the virtual volume of the maximum value mode; in other words, it manages and processes the pool extent ID. The respective functions 640 to 648 are realized by the channel controllers or disk controllers (refer to FIG. 1) executing the control information configured by the management terminal 160 in the storage apparatus 600.

A management server communication processing function 650 of the management server 200B performs the communication processing between the storage subsystem 600 and target server 200A (200C). A permission server and permission port control function 652 commands the permission server and permission port management function 640 of the storage apparatus 600 to perform the processing of newly registering the permission server and permission port and so on. A path configuration control function 653 commands the path configuration management function 642 to perform the processing of newly registering the path configuration and virtual volume information (volume mode and the like). A variable offline volume control function 656 outputs to the variable offline volume management function 646 of the storage subsystem a request received from a variable offline volume operating function 660 of the target server. A variable offline volume extent control function 654 commands the variable offline volume extent management function 644 of the storage subsystem to perform the processing of newly registering the variable offline volume extent; that is, the variable offline volume extent 608. A pool extent control function 658 commands the pool extent management function 648 of the storage subsystem to perform the processing of newly registering the pool extent 610.

A target server communication processing function 660 of the target server (server using the variable offline volume of the business server or backup server) to be applied to the variable offline volume performs the communication processing between a variable offline volume operating function 662 and management server 200B. The variable offline volume operating function 662 maps the virtual volume of the variable offline volume, and outputs to the management server 200B a request for changing the offline volume to an online status, or changing the online volume released from the virtual volume to an offline status.

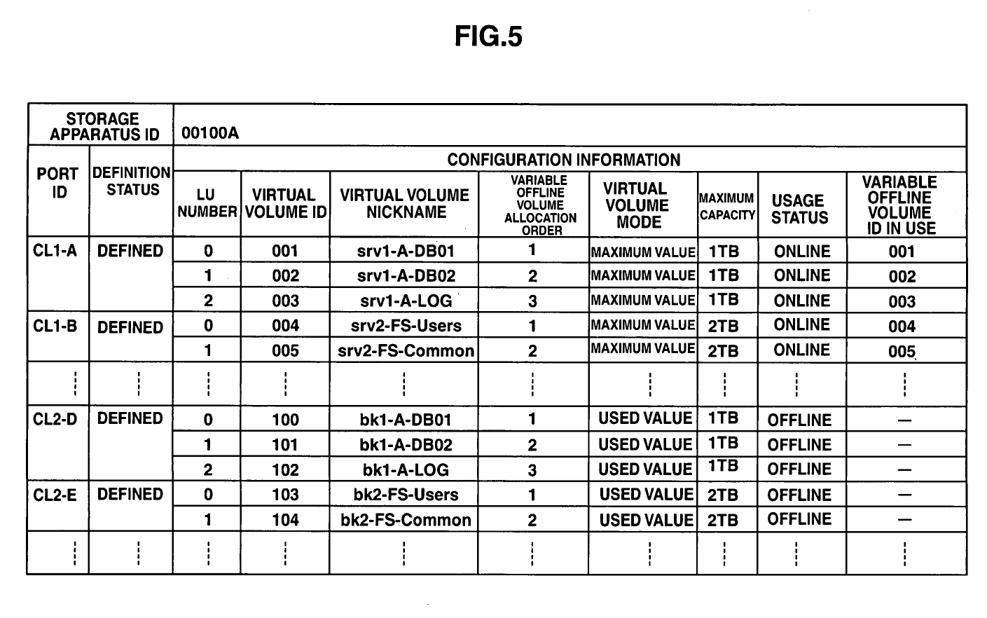

FIG. 5 is a diagram showing a configuration example of the path configuration management table. This path configuration management table is configured in the shared memory 120 (FIG. 1) of the storage apparatus 600. This path configuration management table is configured in the storage apparatus of the ID00100A. A port ID is defined in the virtual volume to be allocated to the CL1-A. This port has LU numbers 0, 1, 2, and virtual volume IDs 001, 002, 003, and a virtual volume nickname is allocated to the virtual volume defined as illustrated in FIG. 5. The server recognizes the virtual volume based on the virtual volume nickname. An allocation order of the variable offline volumes to the respective virtual volumes is determined. The allocation of variable offline volumes will be described in detail later.

A maximum volume mode is configured in the respective virtual volumes. The maximum capacity of the real volume to be allocated to the virtual volume is 1TB. A real volume is allocated to the virtual volume, and the usage status of the variable offline volume is in an online state. Variable offline volumes 001, 002, 003 are respectively allocated to the respective virtual volumes in order. According to FIG. 5, a virtual volume to be connected to a port of the storage apparatus is configured, and a variable offline volume to be allocated to such virtual volume is determined.

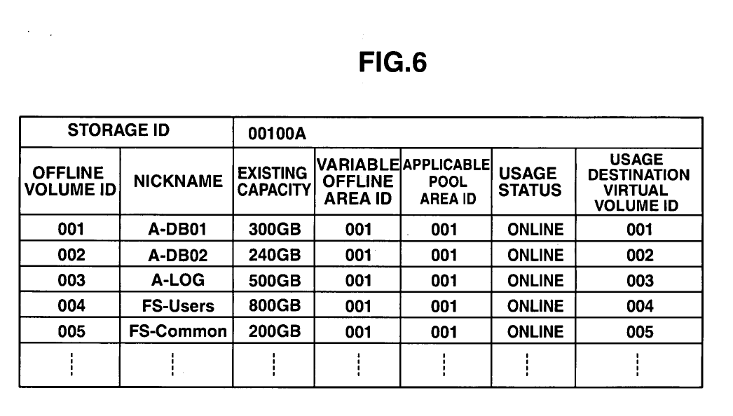

FIG. 6 is a configuration example of the variable offline volume management table configured in the storage apparatus of ID00100A. A nickname is configured in the offline volume shown in the respective IDs. The existing capacity of the respective offline volumes will differ depending on the storage capacity of the physical volume allocated to the variable offline volume. Each offline volume is managed by the storage apparatus since the area ID belongs to 001. A physical volume belonging to the pool ID (001) corresponds to this area ID (001). Online represents a state where the variable volume is allocated to the virtual volume. Usage destination virtual volume ID is the ID of the virtual volume mapped with the respective offline volumes.

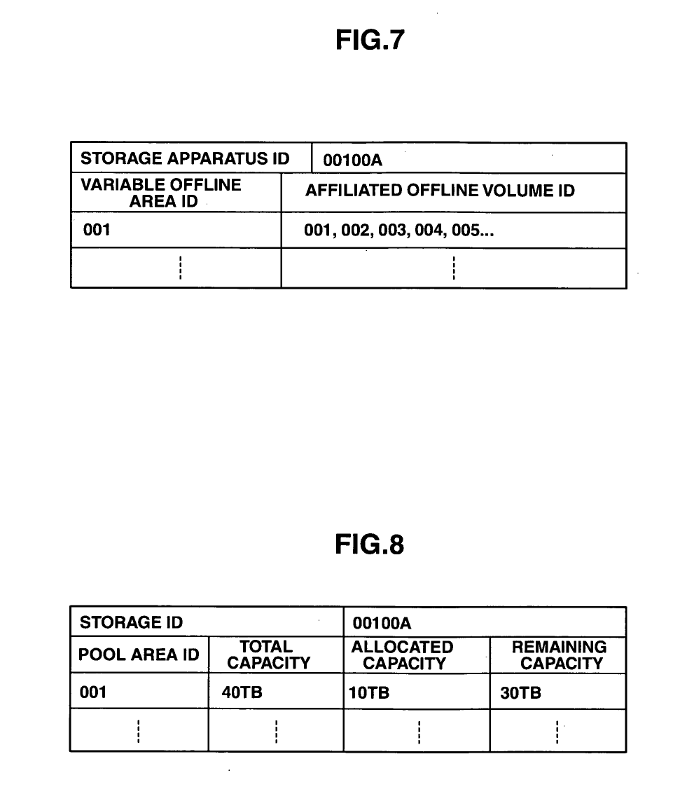

FIG. 7 shows an example of the variable offline area management table. This management table defines the area ID for pooling the variable offline volume and the ID of the offline volume belonging to such area ID. FIG. 8 shows the relationship of the pool extent ID of the pool extent 610 of FIG. 2, total storage capacity of the storage extent belonging thereto, storage capacity allocated to the offline volume, and remaining storage capacity.

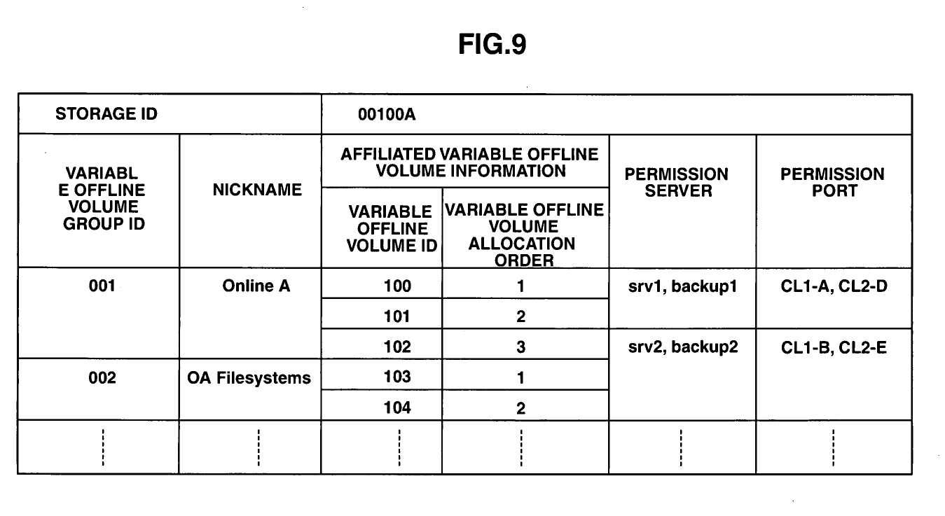

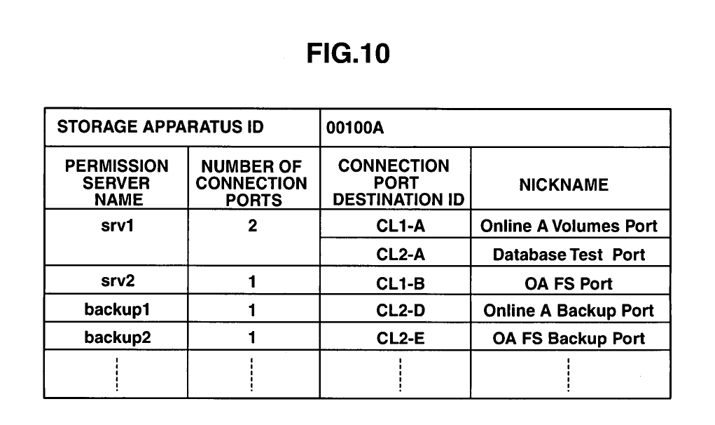

FIG. 9 shows an example of the variable offline volume group (area) management table. This management table configures the ID and nickname in the respective variable offline volume groups (areas). Moreover, the variable offline volume ID belonging to this ID group and the allocation order to the virtual volume are configured in the management table. Moreover, the permission server and permission port of the storage apparatus in which the allocation of the variable offline volume group is permitted are also configured in the management table. FIG. 10 is an example of the permission server and permission port management table. This management table defines the permission server name, number of ports used when the permission server connects to the storage apparatus, ID of the connection port destination, and nickname of the port. By referring to the management tables illustrated in FIG. 5 to FIG. 10, the storage apparatus allows the permitted server to access the virtual volume via the permitted port, allocates a variable offline volume to this virtual volume, and allows the permitted server to access the storage extent of the variable offline volume. Each of these management tables is registered in the shared memory 120 of the storage apparatus.

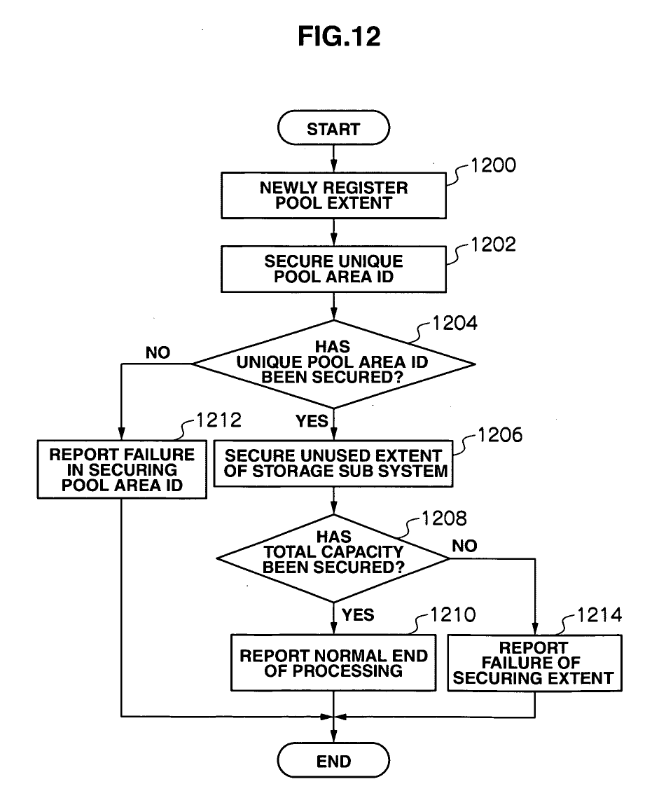

Next, operation of the storage control system shown in FIG. 1 is explained based on the flowcharts of FIG. 12 onward. FIG. 12 shows the operation for initializing the pool extent (610 of FIG. 2) retaining the physical volume allocated to the variable offline volume in the storage apparatus 600. At step 1200, the management server 200B uses the pool extent control function 658 (FIG. 4) to command the pool extent management function 648 of the storage apparatus to newly register the pool extent upon designating the total storage capacity of the pool extent. Next, at step 1202, the pool extent management function 648 of the storage system commanded by the management server secures the unique pool extent ID.

At step 1204, the pool extent management function 648 of the storage subsystem determines whether it was possible to secure the unique pool extent ID. When this is affirmed, at step 1206, the pool extent management function 648 of the storage apparatus 600 secures an unused extent of the storage device of the storage apparatus for the configured pool extent ID. Next, at step 1208, this management function determines whether it was possible to secure the total storage capacity designated by the management server in the storage apparatus.

When this determination is affirmed, at step 1210, the pool extent management function 648 reports to the pool extent control function of the management server that it was possible to secure a storage extent having the entire storage capacity requested in the pool extent, and thereafter ends this processing. When a negative result is obtained in the determination at step 1204, the pool extent management function of the storage apparatus reports the failure in securing the pool extent ID to the pool extent control function of the server (step 1212). Moreover, when a negative result is obtained in the determination at step 1208, the pool extent management function of the storage apparatus notifies the failure in securing the physical storage extent to the pool extent control function 658 of the management server (step 1214). By performing the processing illustrated in FIG. 12, the storage apparatus is able to register the pool extent ID and the storage capacity of the pool extent in the management table described above.

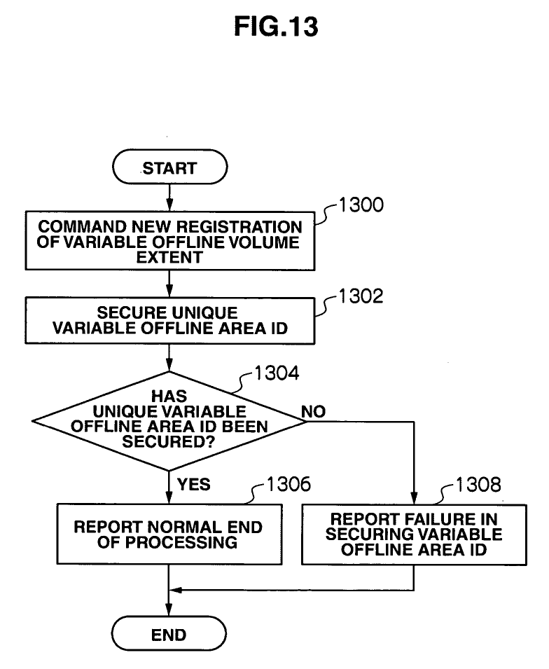

FIG. 13 is a flowchart showing the initialization of the variable offline volume extent. At step 1300, the variable offline volume extent control function 654 of the management server commands the storage apparatus 600 to newly register the variable offline volume extent. At step 1302, the variable offline volume extent management function 644 of the storage apparatus that received the command secures the unique variable offline volume extent ID. At step 1304, the variable offline volume extent management function 644 determines whether it was possible to secure the unique variable offline volume extent ID in the storage apparatus. When a positive result is obtained in this determination, at step 1306, the variable offline volume extent management function of the storage apparatus reports normal completion of processing to the variable offline volume extent control function of the management server. When a negative result is obtained in the determination at step 1304, at step 1308, the variable offline volume extent management function of the storage apparatus reports the failure in securing the variable offline volume extent ID to the variable offline volume extent control function of the management server. As a result of the foregoing processing, it is possible to register the variable offline volume extent ID in the control table described above.

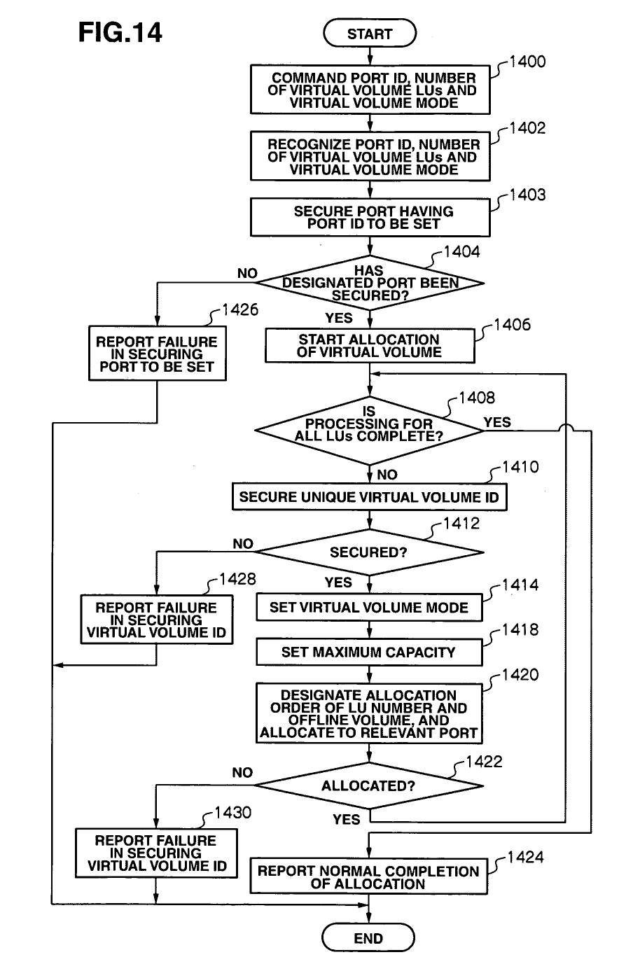

FIG. 14 is a flowchart showing the operation of the initial allocation/path configuration of the virtual volume. At step 1400, the path configuration control function 653 of the management server commands the storage apparatus to configure a new path upon designating the port ID to be configured, number of LUs of the virtual volume to be registered, and the respective virtual volumes. The path configuration management function 642 of the storage apparatus that received this command recognizes the port ID to be configured, number of virtual volume LUs, and virtual volume mode (step 1402).

At step 1403, the path configuration management function 642 secures the port having the port ID to be configured. At step 1404, the path configuration management function 642 determines whether it was possible to secure the designated port. When a positive result is obtained in this determination, at step 1406, the path configuration management function starts the allocation of the virtual volume to the designated port. At step 1408, it is determined whether the processing of all LUs of the virtual volume is complete. When this determination is negated, at step 1410, the path configuration management function secures the unique virtual volume ID in the storage apparatus. At step 1412, the path configuration management function determines whether it was possible to secure the unique virtual volume ID.

At step 1414, the path configuration management function configures a volume mode in the virtual volume. At step 1418, the [path configuration management function] configures the maximum storage capacity in the virtual volume. At step 1420, the path configuration management function designates the LU number of the virtual volume and offline volume allocation order, and subsequently allocates the virtual volume to a specific port. At step 1422, the success or failure of this allocation is determined, and, when a positive result is obtained in this determination, the routine returns to step 1408, and allocation processing of the virtual volume having the subsequent LU number is continued. When a positive result is obtained in the determination at step 1408, at step 1424, the path configuration management function notifies the normal completion of allocation of the virtual volume to the path configuration control function of the management server.

When a negative result is obtained in the determination at step 1404, the routine proceeds to step 1426, and the path configuration management function of the storage apparatus notifies the failure in securing the port to be configured to the path configuration control function of the management server. When a negative result is obtained in the determination at step 1412, at step 1428, the path configuration management function notifies the failure in securing the virtual volume ID to the path configuration control function of the management server. When a negative result is obtained in the determination at step 1422, at step 1430, the path configuration management function notifies the failure in allocating the virtual volume to the path configuration control function of the management server. As a result of the processing explained with reference to FIG. 14, it is possible to register in the management table described above the virtual volume ID, information on the port to which the virtual volume is to be allocated, mode of virtual volume, maximum capacity of virtual volume, and allocation order of the variable offline volume to the virtual volume.

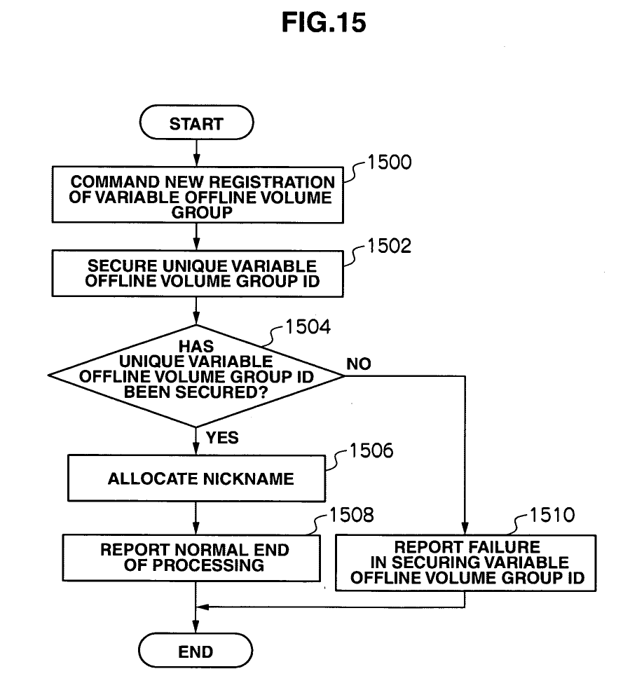

FIG. 15 is a flowchart for explaining the initial allocation of the variable offline volume group. At step 1500, the variable offline volume control [function] 656 of the management server designates a nickname of the variable offline volume group and commands the storage apparatus to newly register the variable offline volume group. At step 1502, the variable offline volume management function 646 of the storage subsystem secures the unique variable offline volume group ID. At step 1504, the variable offline volume management function 646 determines whether it was possible to secure the unique variable offline volume group ID. The variable offline volume management function 646 allocates the designated nickname to the secured variable offline volume group ID.

At step 1508, the variable offline volume management function notifies the normal end of processing to the variable offline volume control function of the management server. At step 1510, the variable offline volume management function of the storage subsystem reports the failure in securing the variable offline volume group ID to the variable offline volume control function of the management server. As a result of the foregoing processing, it is possible to newly register the variable offline volume group to the management table described above.

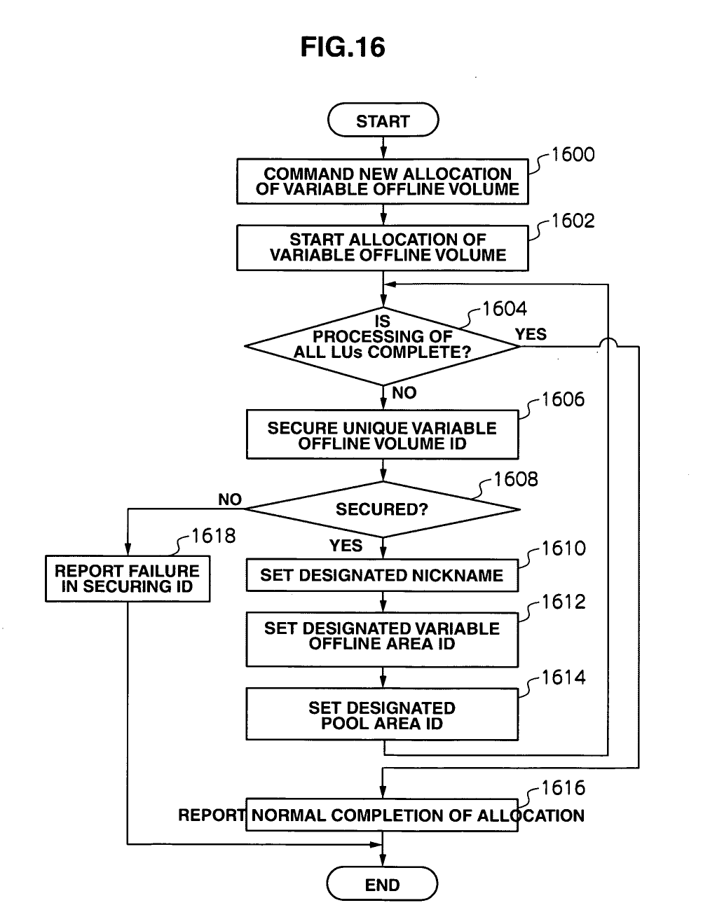

FIG. 16 is a flowchart showing the initial allocation operation of the variable offline volume. At step 1600, the variable offline volume control function 656 of the management server designates the number of LUs of the offline volume to be allocated to the storage apparatus, respective nicknames, pool extent ID of the pool extent to be used in the maximum value mode, and variable offline area ID of the affiliated offline extent, and commands the storage apparatus to newly allocate the variable offline volume (step 1600). The variable offline volume management function 646 of the storage apparatus starts the allocation of the variable offline volume (step 1602). At step 1604, the variable offline volume management function determines whether the allocation of the variable offline volume to all LUs is complete. The variable offline volume management function, at step 1606, secures the unique variable offline volume ID.

At step 1608, the success or failure of such securement is determined. At step 1610, the variable offline volume management function configures the nickname designated at step 1600 in the variable offline volume to be allocated to the storage apparatus. Next, at step 1612, the designated variable offline volume extent ID is similarly configured. Next, at step 1614, the designated pool extent ID is similarly configured. When a positive result is obtained in the determination at step 1604, the routine proceeds to step 1616, and the path configuration management function of the storage subsystem reports the normal completion of allocation to the path configuration control function of the management server. When a negative result is obtained in the determination at step 1608, at step 1618, the variable offline volume management function of the storage subsystem notifies the failure in securing the variable offline volume ID to the variable offline volume control function of the management server. As a result of the processing illustrated in FIG. 16, it is possible to register the virtual offline volume in the management table described above.

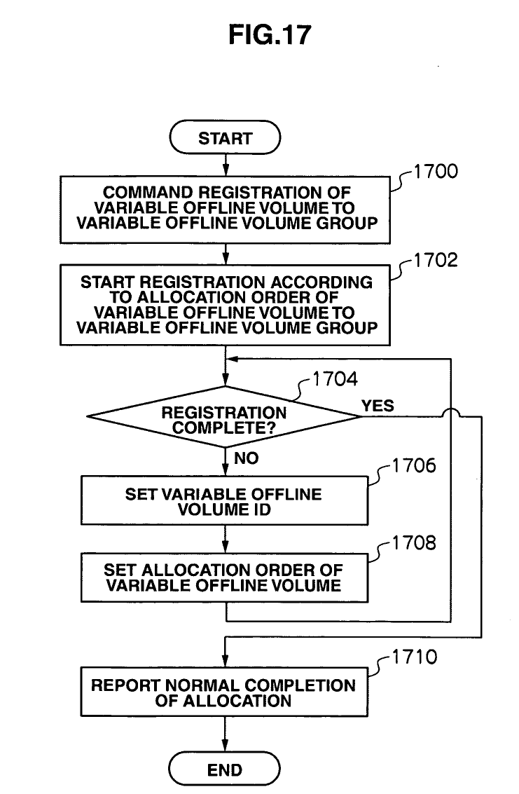

FIG. 17 is a flowchart showing the initial allocation to the variable offline volume group of the variable offline volume. At step 1700, the variable offline volume control function 656 of the management server designates the allocation order upon allocating one or more variable offline volumes to the virtual volume in the storage apparatus, further designates the configured variable offline volume group with an ID or nickname, and commands the storage apparatus to register the variable offline volume in the variable offline volume group (step 1700).

Next, the variable offline volume management function 646 of the storage apparatus registers the variable offline volume in the variable offline volume group according to the allocation order for allocation (step 1702). At step 1704, the variable offline volume management function determines whether the variable offline volume has been registered in all variable offline volume groups. When this determination is negated, the variable offline volume management function configures an ID regarding the variable offline volume (step 1706). At step 1708, an allocation order is configured in the virtual volume regarding the variable offline volume. When the determination at step 1704 is negated, at step 1710, the path configuration management function of the storage subsystem notifies the normal completion of allocation to the path configuration control function of the management server. According to FIG. 17, it is possible to register a specific variable offline volume in the variable offline volume group of the management table described above.

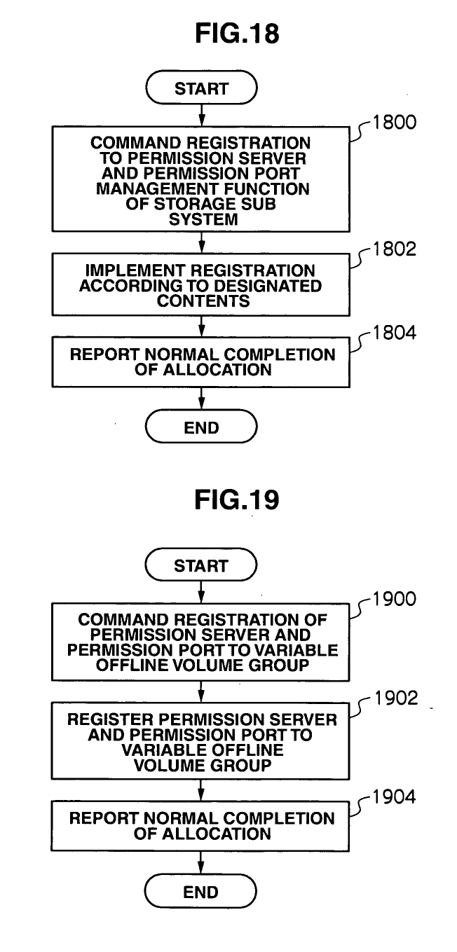

FIG. 18 is a flowchart showing the initial allocation processing of the permission server and permission port. At step 1800, the permission server and permission port control function 652 of the management server designates the server name, number of ports and port ID of the respective ports permitted to use the variable offline volume, and commands the permission server and permission port management function 640 of the storage subsystem to register the permission server and permission port. At step 1802, the permission server and permission port management function of the storage apparatus registers the permission server and permission port in the storage apparatus according to the contents designated by the management server. At step 1804, the permission server and permission port management function of the storage apparatus notifies the normal completion of allocation of the permission server and permission port to the permission server and permission port control function of the management server. According to the processing illustrated in FIG. 18, as shown in FIG. 9, the permission server and permission port are registered in the variable offline volume.

FIG. 19 is a flowchart showing the initial allocation processing to the variable offline volume group of the permission server and permission port. At step 1900, the variable offline volume control function 656 of the management server designates the variable offline volume group to which the variable offline volume is registered based on an ID or nickname, further designates the server name and port ID capable of suing such group, and commands the storage apparatus to register the permission server and permission port in the variable offline volume group. At step 1902, the variable offline volume management function 646 of the storage apparatus registers the permission server and permission port in the variable offline volume group. At step 1904, the path configuration management function of the storage apparatus notifies the path configuration control function of the management server that the allocation of the permission server and permission port to the variable offline volume group has been normally completed. As a result of this processing, it is possible to register the permission server and permission port in the variable offline volume group of the management table.

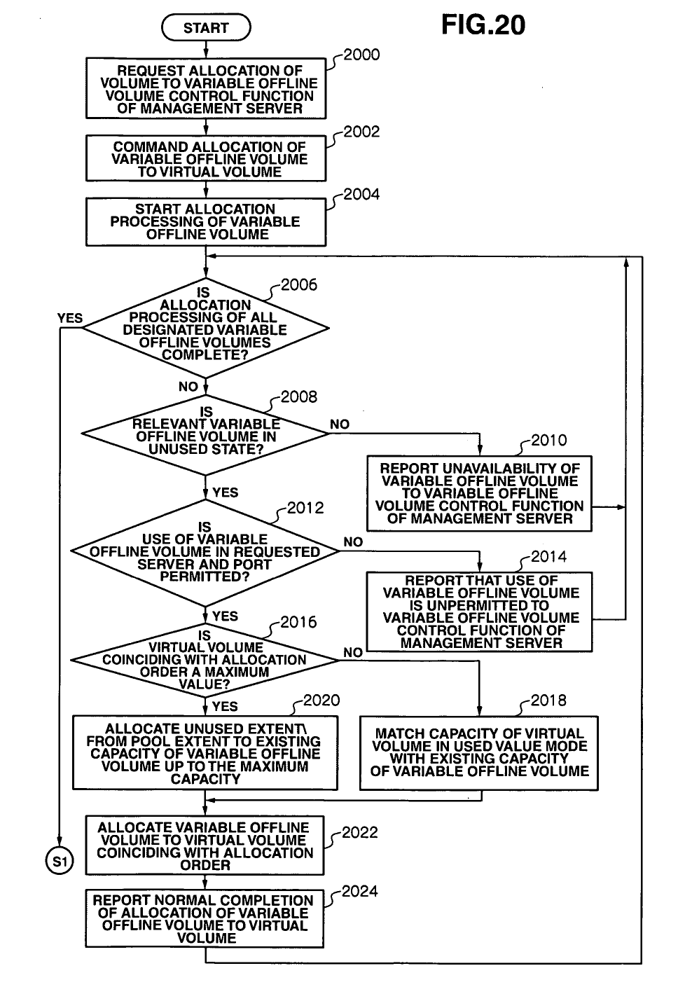

FIG. 20 is a flowchart for explaining the allocation processing to the virtual volume of the variable offline volume. At step 2000, the target server (220B or 200C of FIG. 4) to use the variable offline volume uses the variable offline volume operating function 662 and requests the variable offline volume control function of the management server to allocate the variable offline volume to the virtual volume by designating the variable offline volume to be allocated to the virtual volume of the storage apparatus accessible by the target server in group units based on the variable offline volume group ID or variable offline volume group nickname, or in volume units based on individual variable offline volume ID or nickname, or by designating the port ID, or by designating the individual virtual volume ID or virtual volume nickname.

At step 2002, the variable offline volume control function of the management server commands the variable offline volume management function of the storage subsystem to allocate the variable offline volume to the virtual volume according to the contents of the received request. At step 2004, the variable offline volume management function of the storage apparatus starts the allocation processing of the variable offline volume to the virtual volume.

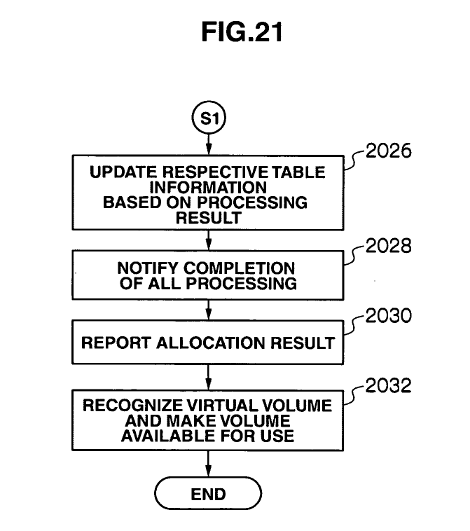

At step 2006, the variable offline volume management function determines whether the allocation of all designated variable offline volumes is complete. When a positive result is obtained in this determination, the routine proceeds to step 2026 of FIG. 21. When a negative result is obtained in the determination at step 2006, the routine proceeds to step 2008, and it is determined whether the variable offline volume to which the virtual volume is to be allocated is in an unused state. When this determination is negated, the routine proceeds to step 2010, and the variable offline volume management function of the storage apparatus notifies the variable offline volume control function of the management server that the variable offline volume is not available.

When a positive result is obtained in the determination at step 2008, the routine proceeds to step 2012, and the variable offline volume management function determines, based on the control table, whether the unused variable offline volume is permitted to be used by a server attempting to use the variable offline volume, and whether the unused variable offline volume is permitted to be allocated to a specific port. When a negative result is obtained in the determination at step 2012, at step 2014, the variable offline volume management function notifies the variable offline volume control function of the management server that the variable offline volume is not available.

Next, at step 2016, the variable offline volume management function determines whether the virtual volume coinciding with the allocation order to the virtual volume configured in the variable offline volume is of a maximum value mode. When this determination is negated, at step 2018, capacity of the virtual volume of the used value mode is matched to the existing capacity (capacity of used extent) of the variable offline volume. When a positive result is obtained in the determination at step 2016, the variable offline volume management function proceeds to step 2020, and allocates the unused storage extent from the pool extent to the virtual volume in the existing capacity of the variable offline volume, and allocates the capacity of the total storage extent up to the maximum capacity of the virtual volume. Incidentally, as described above, the maximum capacity of the virtual volume is decided based on the specification of the server permitted to access the virtual volume.

At step 2022, this variable volume is allocated to the virtual volume having a coinciding allocation order. At step 2024, the variable volume management function notifies the management server that the allocation of the variable volume to the virtual volume has been normally completed.

At step 2006, when the determination is affirmed, the routine proceeds to step 2026 of FIG. 21, and the variable volume management function of the storage apparatus updates the information of the respective management tables described above. At step 2028, the variable offline volume management function of the storage subsystem notifies the completion of all processing to the variable offline volume control function of the management server. At step 2030, the variable offline volume control function of the management server reports the allocation result to the variable offline volume operating function request source target server. At step 2032, the variable offline volume operating function of the request source target server re-recognizes the virtual volume to which the variable offline volume has been normally allocated, and enables a state of inputting and outputting data to and from the virtual volume.

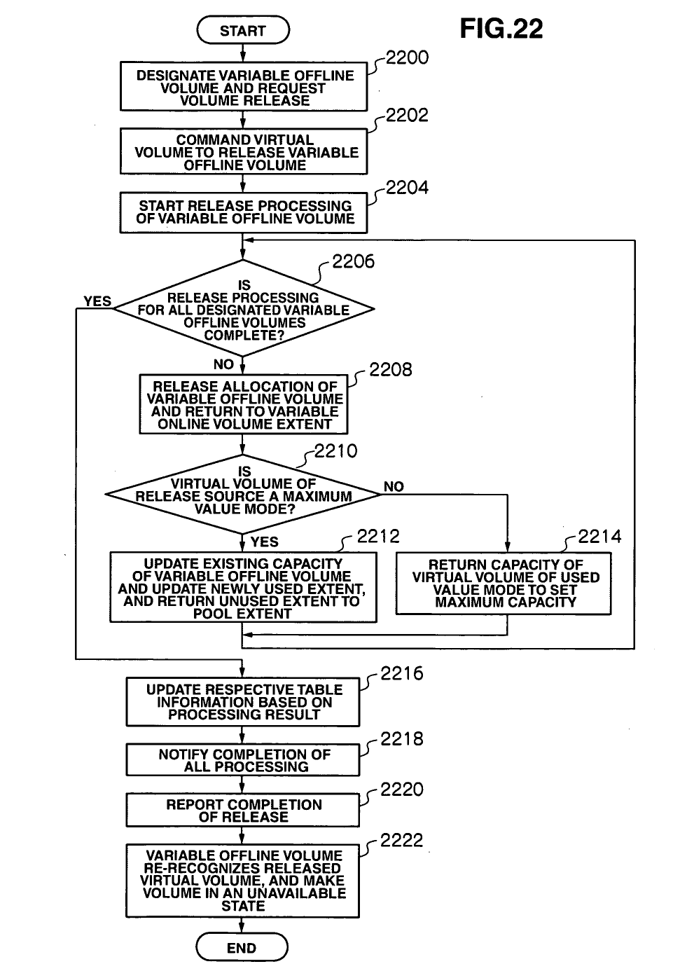

FIG. 22 is a flowchart showing the processing flow of releasing, from the virtual volume, the variable volume that became online by being allocated to the virtual volume. At step 2200, the target server using the variable volume is commanded by the variable offline volume operating function 662 to request the variable offline volume control function of the management server to release the volume by designating the variable volume allocated to the virtual volume in one's own apparatus in group units based on the variable offline volume group ID or variable offline volume group nickname, or in volume units based on individual variable offline volume ID or nickname, or by designating the port ID, or by designating the individual virtual volume ID or virtual volume nickname.

At step 2202, the variable offline volume control function of the management server commands the variable offline volume management function of the storage subsystem to release the variable offline volume to the virtual volume according to the contents of the received request. At step 2204, the variable offline volume management function of the storage subsystem starts the release processing of the variable volume to the virtual volume. At step 2206, the variable offline volume management function determines whether the release processing of all designated variable volumes is complete. When a negative result is obtained in the determination at step 2206, at step 2208, the variable offline volume management function releases the allocation to the virtual volume of the variable volume to be released, and returns the variable volume to the variable offline volume extent.

At step 2210, it is determined whether a maximum value mode is configured in the virtual volume of the release source and, when this determination is affirmed, the routine proceeds to step 2212, and the unused storage extent other than the existing capacity recording data of the variable offline volume and the extent that was newly used and updated by the target server is returned to the pool extent. When a negative result is obtained in the determination at step 2210, capacity of the virtual volume of the used value mode is returned to the configured maximum capacity (step 2214).

When a positive result is obtained in the determination at step 2206, the variable offline volume management function updates the respective table information (step 2216). Next, at step 2218, the variable offline volume management function of the storage subsystem notifies the completion of all processing to the variable offline volume control function of the management server. At step 2220, the variable offline volume control function of the management server reports the completion of release to the variable offline volume operating function of the request source target server. At step 2222, the variable offline volume operating function of the request source target server re-recognizes the virtual volume from which the variable offline volume was released and disables the target server from making a data I/O request to the virtual volume.

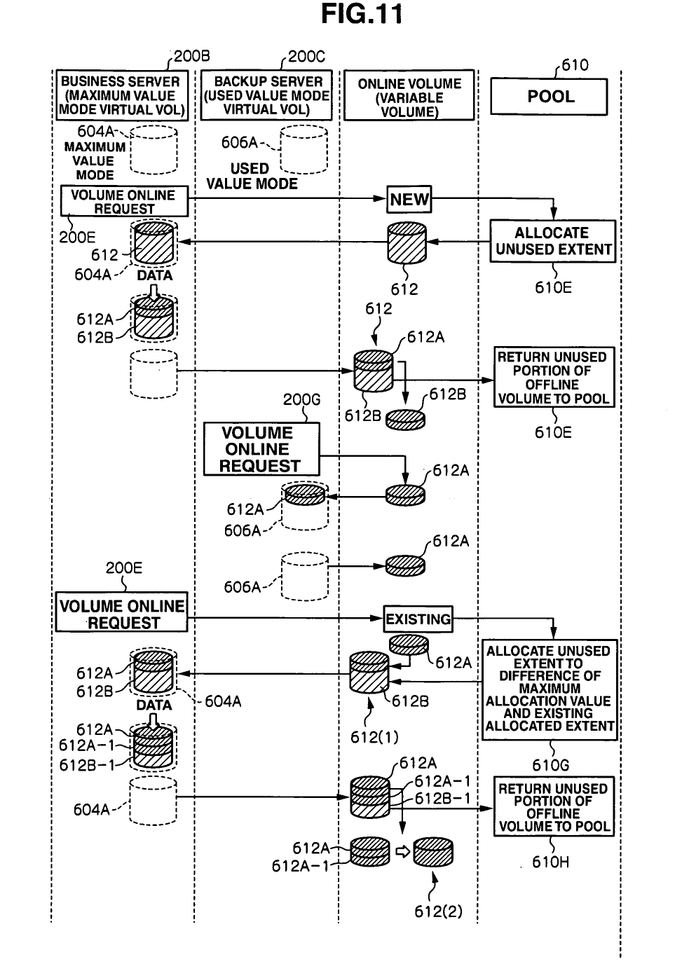

Allocation of the variable offline volume to the virtual volume and the release processing to be performed after such allocation are now explained with reference to FIG. 11. A virtual volume 604A set to the maximum value mode is configured in the business server 200B. When the business server issues a request 200E for making the new offline volume into an online state (step 2000 of FIG. 20), an unused storage extent 610E is allocated to all extents of the new variable offline volume 612 (step 2020). Next, the new offline volume is allocated to the virtual volume and becomes an online state (step 2022).

The business server 200B adds and updates data to the real volume 612 allocated to the virtual volume 604A. Next, after the business server uses the real volume, the real volume 612 is separated from the virtual volume 604A and changed to an offline state (step 2200 of FIG. 22). Next, the storage extent 612A used by the business server is to be managed as an offline volume. The unused storage extent 612B is released from the volume 612 (610F), and returned to the pool 610 (step 2212).

Based on the request 200G from the backup server, the offline volume 612 only having the storage extent 612A substantially used by the business server is allocated to the virtual volume 606A of the backup server and made to be an online state (step 2018, 2020). After data referral processing such as backup is performed, the used extent 612A of the real volume is released from the virtual volume 606A. Only the used extent is managed as an offline volume as is.

In FIG. 11, not only is the new offline volume allocated to the business server, it is also possible to allocate the existing offline volume 612 (1) to the virtual volume 604A. When the offline volume 612 (1) having an existing data storage extent 612A is allocated to the business server 200B, shortage 612B among the total storage capacity requested to the offline volume 612 (1) is newly supplemented from the pool extent (612G). In addition to the portion 612A including the existing data among the offline volume, the storage extent 612A-1 of data added and updated by the business server is managed as an offline volume 612 (2) by the storage apparatus. Here, the storage extent 612B-1 that was not used by the business server is also returned to the pool extent.

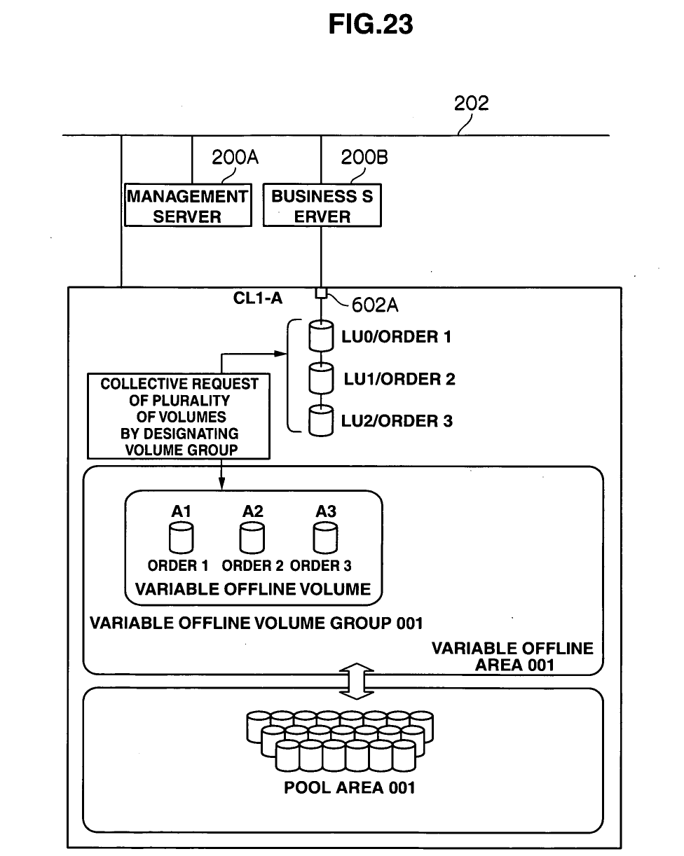

FIG. 23 is a block diagram showing the processing operation of the business server 200B designating a variable offline volume group and collectively allocating a plurality of variable offline volumes to a plurality of virtual volumes (LU0 to LU3). The variable offline volume A1 of the variable offline volume group 001 is foremost allocated to the virtual volume LU0 allocated to the port CL1-A, the variable offline volume A2 is subsequently allocated to the virtual volume LU1, and the variable offline volume A2 is thereafter allocated to the virtual volume LU2. When collectively allocating a plurality of variable offline volumes to a plurality of virtual volumes by the server 200B designating the group 001 of the variable offline volume, as a result of deciding the allocation order of the plurality of variable offline volumes and allocating the variable offline volumes to the virtual volumes in that order, the administrator will not have to go through the trouble of designating the virtual volume as the mapping destination of the respective variable offline volumes in the same group.

According to the embodiments described above, since the volume size of the offline volume can be changed upon allocating the offline volume to the virtual volume, the host system to perform referral processing such as backup will only have to be allocated an offline volume with a reduced offline volume size up to the portion required for backup, and it is possible to shorten the operation time required for backup. In addition, since it is possible to prevent the storage resource required for the backup from being bound by the backup processing during such backup, it is possible to effectively use the storage resource of the storage apparatus.

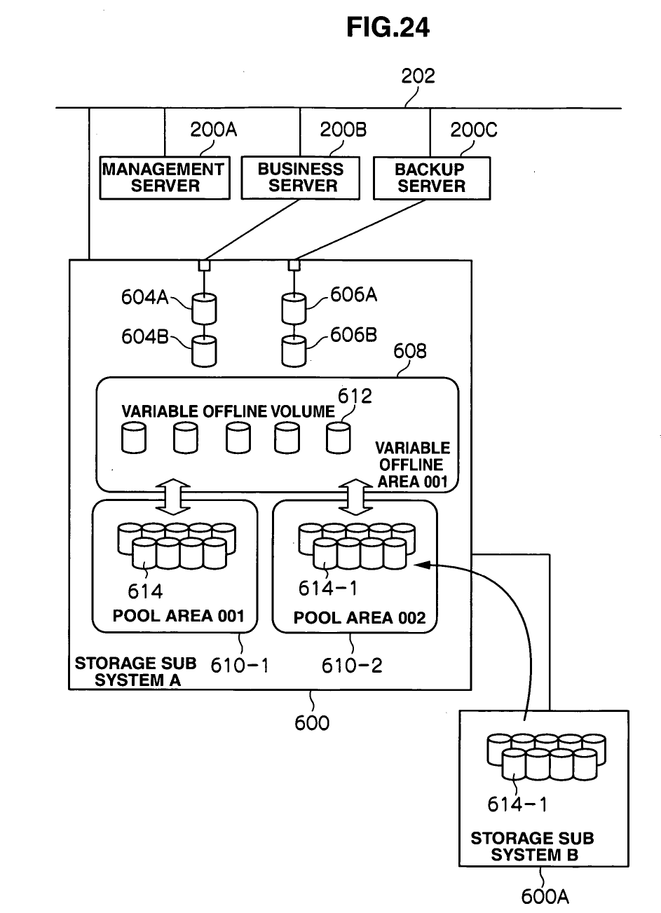

Incidentally, as shown in FIG. 24, the storage extent 614-1 to be allocated to the variable offline volume 612 can also be provided from the other storage apparatus 610A externally connected to the storage apparatus 610. The storage extent 614 of the storage apparatus 610 is allocated to the pool extent 001, and the storage extent 514-1 of the storage apparatus 610A externally connected to the storage apparatus 600 is allocated to the pool extent 002. The storage apparatus of any one of the storage apparatuses is allocated to the variable offline volume 612 of the variable offline volume extent 001. It is also possible to divide the management of the variable offline volumes by providing individual variable offline volume extents to the pool extent allocated inside one's own storage and the pool extent allocated from the externally connected storage. Further, it is also possible to consolidate one's own storage and the extent mapped from the externally connected storage into a single pool extent (area). According to this embodiment, even if the storage resource of one's own storage apparatus runs short, the storage resource of the external storage apparatus can be allocated to the virtual volume (604A, B, 606A, B) of the storage apparatus 600.

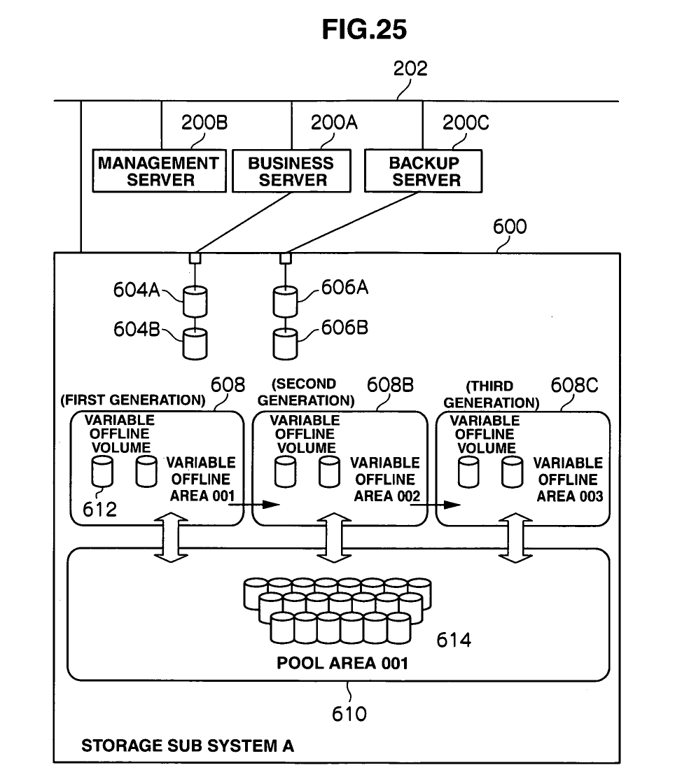

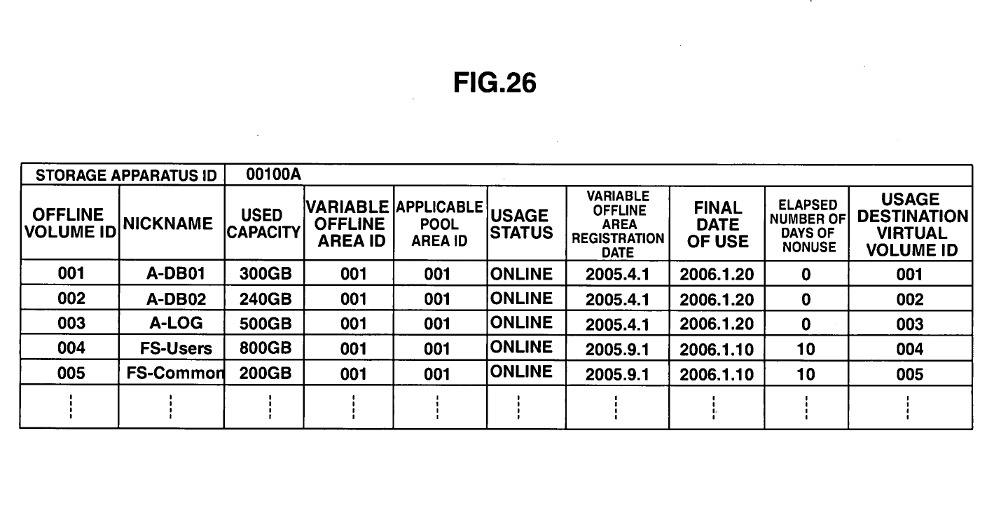

FIG. 25 is a diagram showing a configuration example of the variable offline volume giving consideration to the generation management of data of the variable offline volume. The storage apparatus has a plurality of variable offline volume extents 608, 608A, 608B and manages these based on generation. The management server performs the generation management of the variable offline volumes. In order to realize the generation management of variable offline volumes, the variable offline volume extent registration date, final date of use, and elapsed number of days of nonuse are configured in the variable offline volume management table (FIG. 26). This management table is stored in the management server. The management server, according to the conditions of separating the generation based on the elapsed time or unused period from the newly registered date in the variable offline volume extent, updates the variable offline volume extent ID of the variable offline volume corresponding to the foregoing conditions, updates the registration date (date of update) of the variable offline volume extent, and clears the final date of use and elapsed number of days of nonuse.

The foregoing embodiments described above are merely examples, and may be suitably modified. For instance, in the foregoing embodiments, although a storage apparatus was explained in which the virtual volume recognized by the host system is a primary volume, a sub volume as a mirror volume of the primary volume may also be used as the virtual volume.

What is claimed is:

1. A storage apparatus having a memory apparatus and a controller, and which controls the input and output of data to and from said memory apparatus according to a request from a host system connected via a communication path, including:
a virtual volume to be accessed by said host system; and
a real volume having a storage extent of said memory apparatus;
wherein said host system is configured to access the storage extent of said real volume via said virtual volume by said real volume being allocated to said virtual volume; and
wherein the capacity of the storage extent of said real volume to be allocated to said virtual volume is changeable.

2. The storage apparatus according to claim 1, wherein there are a plurality of virtual volumes, and said controller is configured to execute the processing of allocating said real volume to a first virtual volume and updating the storage extent of said real volume according to a write request from said host system, processing of releasing the allocation of the updated real volume to said first virtual volume, and processing of changing the storage capacity of said real volume upon allocating said real volume to a second virtual volume.

3. The storage apparatus according to claim 2, wherein a plurality of storage extents are accumulated in a pool, and said controller changes the storage capacity of said real volume by changing the quantity of said storage extent to be allocated to said real volume.

4. The storage apparatus according to claim 3, wherein a first host system accesses said first virtual volume and a second host system accesses said second virtual volume.

5. The storage apparatus according to claim 4, wherein said first host system updates said real volume allocated to said first virtual volume and said second host system refers to said real volume allocated to said second virtual volume.

6. The storage apparatus according to claim 5, wherein a maximum storage capacity recognizable by said first host system is configured as said real volume.

7. The storage apparatus according to claim 5, wherein the storage extent used by said first host system is configured in said real volume, and said real volume is allocated to said second virtual volume.

8. The storage apparatus according to claim 1, wherein the storage capacity of said real volume to be allocated to said virtual volume is determined based on the type of business to be executed by a server as said host system.

9. The storage apparatus according to claim 5, wherein said second host system is a backup server.

10. The storage controller according to claim 5, wherein said controller determines the storage capacity of said real volume based on a control table configuring the modes relating to the storage capacity of said real volume to be allocated to said virtual volume.

11. The storage apparatus according to claim 9, wherein a first mode of configuring to said real volume the maximum storage capacity recognizable by said host system to access said first virtual volume is configured in said first virtual volume, and a second mode of mapping to said real volume a storage extent among the storage extents of said real volume to which data has been written from said host system is configured in said second virtual volume.

12. The storage apparatus according to claim 10, wherein said second mode is configured in said virtual volume to be allocated to a backup server as said host system.

13. The storage apparatus according to claim 4, wherein said controller returns to said pool the storage extent not being used by said host system among the storage extents to be allocated to said first virtual volume, and allocates the used storage extents to said second virtual volume.

14. A storage control method of a storage apparatus having a memory apparatus, a controller for controlling the input and output of data to and from said memory apparatus according to a request from a host system connected via a communication path, a virtual volume to be accessed by said host system, and a real volume having a storage extent of said memory apparatus,
wherein said controller executes the steps of:
enabling said host system to access the storage extent of said real volume via said virtual volume by allocating said real volume to said virtual volume; and
changing the capacity of the storage extent of said real volume upon allocating said real volume to said virtual volume.
